(19) United States
(12) Patent Application Publication
(10) Pub. No.: US 2014/0195125 A1
(43) Pub. Date: Jul. 10, 2014

(54) MOTOR VEHICLE

(71) Applicants: Andreas Siegel, Ingolstadt (DE); Michael Reichel, Ingolstadt (DE)

(72) Inventors: Andreas Siegel, Ingolstadt (DE); Michael Reichel, Ingolstadt (DE)

(73) Assignee: AUDI AG, Ingolstadt (DE)

(21) Appl. No.: 14/241,707

(22) PCT Filed: Jul. 7, 2012
(86) PCT No.: PCT/EP2012/003203

§ 371 Date: Feb. 27, 2014

(30) Foreign Application Priority Data
Sep. 2, 2011 (DE) 102011112370.2

(51) Int. Cl. G05D 3/00; B60H 1/00; B60N 3/00

(52) U.S. Cl. CPC G05D 3/00; B60N 3/00; B60H 1/00742
USPC 701/49; 701/1; 701/36

(57) ABSTRACT

A motor vehicle has a position detection device and a control device. The position detection device detects a piece of position information that describes the position of at least one occupant of the motor vehicle and/or of a mobile terminal, particularly a mobile telephone, that is associable or associated with the occupant within the motor vehicle by taking account of a position of the mobile terminal and/or of a piece of registration information delivered by the mobile terminal. The control device is designed to set at least one operating parameter of a vehicle system by taking account of a piece of control information delivered by the mobile terminal and of the position information and/or to transmit at least one piece of operating information that influences at least one function of the mobile terminal to the mobile terminal on the basis of the position information.

### CROSS REFERENCE TO RELATED APPLICATIONS

This application is based on and hereby claims priority to International Application No. PCT/EP2012/003203 filed on Jul. 27, 2012 and German Application No. 10 2011 112 370.2 filed on Sep. 2, 2011, the contents of which are hereby incorporated by reference.

### BACKGROUND

The invention relates to a motor vehicle.

It is known practice for mobile terminals to be connected to a motor vehicle by a communication link. It is thus possible, for example using an existing data link between a mobile telephone and a vehicle system in the form of a communication system, to conduct telephone calls via the loudspeakers provided in the interior of the motor vehicle and via a microphone provided in the interior of the motor vehicle in the fashion of a hands-free installation.

Fundamentally, the carrying of a mobile terminal, particularly a mobile telephone, particularly by the driver, can be regarded as a source of danger, since this, particularly in the case of incoming calls or text messages, is regularly a distraction for the driver, after which he devotes his attention not exclusively to what is happening in the traffic but rather to the mobile terminal, particularly the mobile telephone.

A further way of distracting the driver's attention from what is happening in the traffic is provided by settings for relevant operating parameters of relevant vehicle systems provided on the motor vehicle, which are often fundamentally complex to perform and the performance of which accordingly, particularly when travelling in dense traffic, may be a source of danger. An example that may be mentioned is the operator control of an air conditioning system that relates to the air conditioning for the interior of the motor vehicle, which may comprise a multiplicity of temperature, fan-strength and area settings.

### SUMMARY

One possible object is to improve a motor vehicle such that the danger from distractions to an occupant, particularly the driver, that can be attributed particularly to the operator control of vehicle systems provided on the motor vehicle and/or of mobile terminals is reduced.

The inventors propose a motor vehicle comprising a position detection device for detecting a piece of position information that describes the position of at least one occupant of the motor vehicle and/or of a mobile terminal, particularly a mobile telephone, that is associable or associated with the occupant within the motor vehicle by taking account of a position of the mobile terminal and/or of a piece of registration information delivered by the mobile terminal, and also a control device that is designed to set at least one operating parameter of a vehicle system by taking account of a piece of control information delivered by the mobile terminal and of the position information and/or to transmit at least one piece of operating information that influences at least one function of the mobile terminal to the mobile terminal on the basis of the position information.

The inventors' proposals are based on the concept of firstly making settings for relevant operating parameters of relevant vehicle systems provided on a motor vehicle on the basis of the position of at least one occupant of the motor vehicle and/or the position of a mobile terminal, that is to say particularly a mobile telephone, that is associable or associated with an occupant, as a result of which said settings are made on the basis of the detected position of the occupant and/or of the mobile terminal, and secondly, as an alternative or in addition, likewise taking the position of the occupant and/or the mobile terminal that is associable or associated therewith as a basis for influencing, i.e. particularly restricting, relevant functions of the mobile terminal by the transmission of relevant operating parameters to the mobile terminal.

In order to ascertain the position of the at least one occupant within the motor vehicle or of the at least one mobile terminal that is associable or associated with the occupant, a position detection device is provided that ascertains a piece of position information that describes the position of an occupant and/or of the mobile terminal that is associable or associated with the occupant within the motor vehicle by taking account of the current position of the mobile terminal and/or of a piece of registration information delivered by the mobile terminal and/or possibly of the current position of the occupant. That is to say that the current position of the occupant, which can be ascertained by the position detection device in a manner that will also be mentioned later, and/or the current position of the mobile terminal, which is obtained from a piece of registration information transmitted to the motor vehicle by said mobile terminal, for example, is/are converted into the position information.

Accordingly, the position information may describe a seat position and/or role of the occupant within the motor vehicle, for example. The seat position indicates the seat provided on the motor vehicle (drivers seat, front-seat passenger's seat, rear seat, etc.) in which an occupant is sitting. The role of the occupant within the motor vehicle, which can generally be distinguished according to the role of the occupant as a driver or passenger, the role as passenger also being able to be distinguished by the front-seat passenger seated next to the driver and further passengers, is possibly likewise relevant to the setting of relevant operating parameters and particularly to the influencing of relevant functions of relevant mobile terminals. The influencing of relevant functions of a mobile terminal, particularly of a driver's mobile terminal, means a reduction in the distraction potential that comes from the mobile terminal, which distraction potential usually means a high level of danger in respect of driving errors related to inattentiveness.

The position information is transmitted to a control device by a data link, particularly a vehicle bus, which control device makes a setting for a relevant operating parameter on the basis of a piece of control information delivered by the mobile terminal and on the basis of the position information. A relevant piece of control information transmitted by the mobile terminal is intended to be understood to mean a piece of information that is relevant to the control of at least one operating parameter of at least one vehicle system and that, by way of example, is transmitted to a control device associated with the vehicle system, as a result of which said control device makes a relevant change or customization for an operating parameter. The dependency of the setting of the operating parameter on the position information arises, by way of example, from the fact that said setting is made only in relation to an area, that is to say only for that area situated within the motor vehicle that is described by the position information. Thus, by way of example, in the case of a piece of position information that describes the position of an occupant in the front left area of the passenger compartment or in the case of a piece of position information that describes the position of a mobile terminal associated with the occupant in the front left area of the passenger compartment, it is possible for a setting for an air conditioning installation accordingly to be made only for the front left area of the passenger compartment, and therefore the area of the driver. The above example relates to a motor vehicle that is designed for right-hand traffic. The principle according to the inventors' proposals can naturally also be transferred to motor vehicles that are designed for left-hand traffic.

The setting of the vehicle system can relate to a vehicle assistance system and/or a multimedia system and/or an air-conditioning system and/or an interior lighting system and/or an actuating system for at least one door and/or for a window and/or a system for adjusting a seat position, for example. The listing is not conclusive. Fundamentally, it is possible for operating parameters of any vehicle systems that are present on the motor vehicle to be set accordingly.

As an alternative or in addition, it is possible for the control device to transmit a piece of operating information that influences, particularly restricts, at least one function of the mobile terminal to the mobile terminal. In this case, the content of the operating information that influences the at least one function of the mobile terminal is in turn determined by the position information, that is to say that the content of the operating information that is relevant to the control of the functionality of the mobile terminal is produced on the basis of the position information. Therefore, different operating information is accordingly transmitted to the mobile terminal by taking account of the current position of the mobile terminal within the motor vehicle, as a result of which, when a mobile terminal that is located in the front left area—with reference to a motor vehicle that is designed for right-hand traffic—of the passenger compartment, that is to say in the area of the driver, is detected, for example, a piece of operating information that brings about more distinct influencing, that is to say particularly restriction, of the functionality of the mobile terminal in comparison with other positions within the motor vehicle is transmitted to the mobile terminal or to a control device associated therewith.

A mobile terminal is intended to be understood to mean any electronic portable apparatus that is associable or associated with an occupant and that has at least one function. Besides the cited example of a mobile telephone, particularly a smart phone, this is also intended to be understood to mean portable multimedia devices, such as notebooks, MP3 players, etc.

By way of example, the setting of a function of the mobile terminal may be limitation of the reception of incoming information contents, particularly of incoming telephone calls, text and/or multimedia messages, and/or reduction of the contents shown on a display of the mobile terminal and/or reduction of the brightness of said contents and/or shutdown of the display and/or reduction of the volume or intensity of signal tones from the mobile terminal and/or shutdown of signal tones and/or a reduced intensity of vibration signals from the mobile terminal and/or shutdown of vibration signals and/or shutdown of the mobile terminal. The list is not conclusive. Fundamentally, any function of a relevant mobile terminal, particularly a mobile telephone, can be influenced by a relevant piece of operating information.

Accordingly, the proposals allow position-specific setting of relevant operating parameters of relevant vehicle systems and/or position-specific influencing of relevant functions of a mobile terminal that is associable or associated with an occupant by taking account of the current or actual position of the occupant or of the mobile terminal that is associable or associated with the occupant. Therefore, the position information describing the position of the occupant or of the mobile terminal that is associable or associated therewith can be used firstly for position-specific or area-related settings for relevant operating parameters, as a result of which it is possible for relevant settings to be made with less complexity. By way of example, the position information, as mentioned, can easily be used to make an area-related temperature setting for an air conditioning system.

Secondly, the alternatively or additionally implementable influencing, particularly limitation, of relevant functions of the mobile terminal induces a reduction in the distraction potential of the mobile terminal for an occupant, that is to say particularly the driver. As is evident from the examples cited above for possible influencing of functions in respect of a driver's mobile telephone, a relevant piece of operating information can induce limitation of the volume of relevant signal tones from the mobile telephone, for example, which means that the driver is distracted less by incoming telephone calls or text messages. A menu structure for a mobile terminal that is customized on the basis of the position of the occupant is also conceivable, as a result of which it is possible to set a particularly easily understandable, possibly reduced menu structure for a mobile terminal belonging to an occupant acting as driver, for example.

Various exemplary options for the ascertainment of the position information that is performed by the position detection device are given below.

The position detection device may be designed to ascertain the position information using terminal-specific motion signals delivered by a motion sensor system associated with the mobile terminal. The terminal-specific motion signals, which cover acceleration signals or relevant rotation rates that describe accelerations acting on the motion sensor system, for example, accordingly allow conclusions as to the position of the mobile terminal. This applies particularly when the or a starting position of the mobile terminal is known.

In addition, at least one motor-vehicle-based motion sensor system delivering motor-vehicle-specific motion signals may be provided, wherein the position detection device is designed to ascertain the position information by taking account of the motor-vehicle-specific motion signals. Accordingly, the position information is obtained particularly from the difference between the motor-vehicle-specific motion signals and the terminal-specific motion signals. In other words, the motion of the motor vehicle that can be attributed to a journey on uneven ground, for example, which is reflected in corresponding motor-vehicle-specific motion signals, can be distinguished, that is to say filtered, from the terminal-specific motion signals, as a result of which exclusively terminal-specific motion signals, which describe the motions of the mobile terminal relative to the motor vehicle, are taken into account for ascertaining the position information.

It is possible for the position detection device to be designed to ascertain the position information using the lateral acceleration that acts on the mobile terminal, said lateral acceleration varying on the basis of the position within the motor vehicle during a curve through which said motor vehicle is travelling. This embodiment is based on the principle that mobile terminals arranged at radial distances from a line that forms the longitudinal center axis of the motor vehicle have different lateral accelerations acting on them when travelling through a curve, said lateral accelerations being proportional to the radius of the curve according to the relation a_{z}=ω×(ω×r) (where a_{z}: lateral acceleration, ω: angular velocity, r: radius of the curve). Thus, when travelling through a right-hand curve, for example, the lateral acceleration acting on a mobile terminal located on the driver side, that is to say to the left of the longitudinal center axis of the motor vehicle, is higher than for a mobile terminal located on the front-seat passenger side, that is to say to the right of the longitudinal center axis. This is evident from the respective different radii of the curves, since the mobile terminal located on the driver side effectively travels through a curve for the greater radius in comparison with the mobile terminal located on the front-seat passenger side.

In this connection, it is particularly possible to detect the motion signals delivered by the respective motion sensor systems over a defined period, that is to say when travelling through multiple curves, and to evaluate them accordingly. In this respect, the motion signals delivered by a first motion sensor system over a relatively long period when travelling through right-hand curves, for example, in comparison with the motion signals delivered by at least one further motion sensor system in a further mobile terminal or a motion sensor system installed on the motor vehicle, from which comparison a higher lateral acceleration acting on the first motion sensor system is established, for example, can be used to infer that the first motion sensor system and hence the mobile terminal carrying it is arranged on the driver side.

Expediently, a terminal-based and/or motor-vehicle-based motion sensor system comprises at least one inertial sensor. Inertial sensors are used to detect rotational and/or translational movements and are therefore suitable for ascertaining relevant accelerations, rotation rates, etc. Depending on the number of inertial sensors forming the respective motion sensor system, high-resolution representation of motions is therefore possible. A motion sensor system may comprise three to six inertial sensors, for example.

As an alternative or in addition, the position detection device may be designed to ascertain the position information using a piece of locating information delivered by at least one locating antenna, provided on the motor vehicle, for locating the mobile terminal. Locating antennas particularly allow relevant mobile terminals to be located, as a result of which the position information ascertained therefrom can directly describe the position of a relevant mobile terminal and can indirectly describe a position of an occupant with whom the mobile terminal is associated. The locating antennas operate on the principle of radio location, according to which a signal intensity can be varied on the basis of the distance of the mobile terminal from the respective locating antenna and accordingly a position of the mobile terminal can be inferred. It goes without saying that the motor vehicle may have a plurality of locating antennas arranged in a defined distribution over the interior of the mobile vehicle, that is to say arranged on each seat, for example, with conclusions as to the position of a mobile terminal being able to be obtained from the strongest signal in each case, for example.

It is also conceivable for the position detection device to be designed to ascertain the position information using picture data that are recorded using a camera in the mobile terminal, show the or a portion of the interior of the motor vehicle and allow conclusions as to the position of the occupant and/or of the mobile terminal. Accordingly, relevant information that the picture data contain can be used to draw conclusions as to the recording location, that is to say the position of the occupant or of the mobile terminal. For this, the position detection device comprises suitable picture evaluation mechanism that allow features that are characteristic of the respective position within the motor vehicle, such as a steering wheel or the back of a driver's seat, to be ascertained and these features to be used to draw relevant conclusions as to the position of the occupant or of the mobile terminal. Relevant picture data can be recorded manually by an occupant or automatically by the mobile terminal. The latter variant is particularly useful when the mobile terminal recognizes from communication with the motor vehicle that it is located within the motor vehicle.

It is also possible for the position detection device to be designed to ascertain the position information using a piece of registration information, particularly one that contains a piece of position information, that relates to registration of the mobile terminal with the motor vehicle. According to this embodiment, the mobile terminal is registered with the motor vehicle, that is to say logged into the latter, automatically or manually. The registration information, which contains information about the mobile terminal that needs to be registered being able to be associated with the driver, for example, can likewise be used to ascertain a position. Accordingly, when a mobile terminal has been registered as being associated with the driver, it can be assumed that it is located on or in the area of the driver's seat.

The interior of the motor vehicle may contain at least one marker that can be detected by the mobile terminal, wherein the mobile terminal, upon detecting the marker, is designed to produce a piece of auxiliary position information and to transmit the latter to the position detection device, which is designed to use the transmitted auxiliary position information to ascertain the position information. Accordingly, upon detection of a relevant marker that is arranged at a defined location in the interior of the motor vehicle, the mobile terminal can produce a relevant piece of auxiliary position information and transmit it to the position detection device, which uses the auxiliary position information, which contains information about a marker arranged in the area of the driver's door, for example, to ascertain a relevant piece of position information. In the example cited above, the position information describes the position of the mobile terminal or of the occupant for the area of the drivers seat. The markers can again be detected manually by virtue of an occupant actuating a relevant function of the mobile terminal or automatically by the mobile terminal. Expediently, each seat within the motor vehicle has at least one associated marker.

Fundamentally, the position detection device may be designed to repeatedly ascertain a piece of position information for a mobile terminal, particularly one that has already been detected in a position by a piece of position information. Accordingly, changes in the position of a mobile terminal, for example when it is put onto the back seat of the vehicle, can be detected, with a check being performed, in particular continuously or intermittently, to determine whether the position information associated with a mobile terminal has changed. In this case, comparisons of current position information with an originally ascertained piece of position information, if need be stored in a storage, are conceivable, in particular.

The setting of the operating parameter of the vehicle system and/or of the function of the mobile terminal is temporary, in particular. It goes without saying that the influencing of functions is not intended to be understood to mean that the operating information that influences the at least one function of the mobile terminal reconfigures the mobile terminal such that it is no longer able to output signal tones at all, for example. By way of example, the term “temporary” relates to the period in which the mobile terminal is located within the motor vehicle, and can therefore describe a particular time interval. If need be, temporary influencing of the function of the mobile terminal can also be linked to at least one additional criterion, such as vehicle operation or a particular operating parameter, such as a prescribed or prescribable minimum speed, of the motor vehicle, as a result of which appropriate setting of an operating parameter or influencing of a function of the mobile terminal is in force only when the criterion is present. In this case, the influencing of functions is accordingly effected dynamically on the basis of the presence of the at least one criterion.

In a development, the motor vehicle has at least one transmission and/or reception device that forms particularly a portion of a motor-vehicle-based wireless network and by which it is designed to communicate with the mobile terminal. The motor-vehicle-based transmission and/or reception device is accordingly designed to communicate with an appropriate transmission and/or reception device that forms part of the mobile terminal, which transmission and/or reception devices can set up a communication link to one another. The wireless network may be a WLAN or Bluetooth network, for example.

Expediently, the control device may be designed to take account of at least one current piece of operating information from the motor vehicle and/or of at least one current piece of traffic information when setting the at least one operating parameter and/or the at least one function of the mobile terminal. This aspect relates particularly to the influencing of the at least one function of the mobile terminal, which can accordingly take place only when a minimum speed (e.g. 30 km/h) that can be deemed to be operating information from the motor vehicle is exceeded (in this regard cf. also the section relating to the temporary influencing of the at least one function of the mobile terminal). Equally, it is also possible to take account of traffic information, such as a potential dangerous situation ahead of the vehicle, as a result of which the functionality of the mobile terminal is influenced only when corresponding hazard reports are available. It goes without saying that the operating information from the motor vehicle, which can be understood to mean not only the aforementioned actual speed but also engine speeds, accelerations, yaw rates etc., for example, or the traffic information can also induce greater influencing of the functionality of the mobile terminal. By way of example, the mobile telephone detected on the driver side can be switched to silent by a first piece of operating information, and when a speed of 100 km/h, for example, is exceeded a further piece of operating information is transmitted that completely suppresses the reception of incoming calls or text messages.

Advantageously, the motor vehicle comprises at least one plausibilization device that is designed to check the position information ascertained by the position detection device. By way of example, the plausibilization device may be in the form of a seat occupancy sensor system, cameras provided in the interior of the motor vehicle or the like and can additionally provide information about the position of an occupant and/or of a mobile terminal that is associable or associated therewith. Accordingly, a seat occupancy sensor system can be used to check whether a piece of position information that is ascertained by the position detection device and that describes a position of an occupant on the driver's seat is valid insofar as an occupant is actually sitting in the driver's seat.

In addition, the inventors propose a method for setting at least one operating parameter of at least one vehicle system in a motor vehicle and/or at least one function of at least one mobile terminal, particularly a mobile telephone, that is associable or associated with an occupant of the motor vehicle. The method comprises the steps of ascertaining at least one piece of position information that describes the position of at least one occupant of a motor vehicle and/or of a mobile terminal, particularly a mobile telephone, that is associable or associated with the occupant within the motor vehicle by taking account of the position of the mobile terminal and/or of a piece of registration information delivered by the mobile terminal, and also setting at least one operating parameter of a vehicle system by taking account of a piece of control information delivered by the mobile terminal and of the position information and/or transmitting and setting at least one piece of operating information that influences at least one function of the mobile terminal to the mobile terminal on the basis of the position information.

According to the method, provision is accordingly first of all made for a piece of position information that describes the position of at least one occupant of a motor vehicle and/or of a mobile terminal, particularly a mobile telephone, that is associable or associated with an occupant within the motor vehicle to be ascertained. The position information, which describes particularly a seat position and/or a role of the occupant within the motor vehicle, accordingly indicates the area within the motor vehicle that contains an occupant or a mobile terminal. On the basis of the position information, at least one operating parameter of a vehicle system is set by taking account of a piece of control information delivered by the mobile terminal and of the position information and/or transmitting at least one piece of operating information that influences at least one function of the mobile terminal to the mobile terminal. The at least one operating parameter of the relevant vehicle system is set up by a control device that is provided either on the motor vehicle or on the terminal and that delivers relevant control commands to the respectively affected vehicle system.

Fundamentally, all of the statements regarding the motor vehicle apply to the method.

Accordingly, the position detection device can ascertain the position information using terminal-specific motion signals delivered by a motion sensor system associated with the mobile terminal, for example.

Provided that at least one motor-vehicle-based motion sensor system delivering motor-vehicle-specific motion signals is provided, the position detection device advantageously ascertains the position information by taking account of the motor-vehicle-specific motion signals. In this case, it is particularly possible to distinguish motions of the motor vehicle from motions of the mobile terminal, which means that the latter effectively describe a relative motion of the mobile terminal in relation to the motor vehicle, which is then taken as a basis for ascertaining the position information.

In particular, it is possible for the position detection device to ascertain the position information using the lateral accelerations that act on the mobile terminal, said lateral accelerations varying on the basis of the position within the motor vehicle during a curve through which said motor vehicle is travelling.

The terminal-based and/or motor-vehicle-based motion sensor systems used within the context of the method preferably comprise at least one inertial sensor. On the basis of the number of inertial sensors forming the respective motion sensor systems, it is therefore possible for motions or motion sequences of the mobile terminal or of the motor vehicle to be presented at high resolution.

It is possible for the position detection device to ascertain the position information using a piece of locating information delivered by at least one locating antenna, provided on the motor vehicle, for locating the mobile terminal. In this case, the position information is ascertained on the basis of radio locating, according to which it is possible to infer a position of a mobile terminal on the basis of an intensity signal that varies on the basis of the distance of the mobile terminal from one or more locating antennas. Fundamentally, the mobile terminal may also have appropriate locating antennas, as a result of which said mobile terminal is able to detect a distance from a steering wheel, for example, which distance is then transmitted as locating information to the motor vehicle and is used therein to ascertain the position information.

It is also conceivable for the position detection device to ascertain the position information using picture data that are recorded using a camera in the mobile terminal, show the or a portion of the interior of the motor vehicle and allow conclusions as to the position of the occupant and/or of the mobile terminal.

In addition, the position detection device can ascertain the position information using a piece of registration information, particularly one that contains a piece of position information, that relates to registration of the mobile terminal with the motor vehicle.

It is also conceivable for the mobile terminal to detect at least one marker arranged within the interior of the motor vehicle, wherein the mobile terminal, upon detecting the marker, detects a piece of auxiliary position information and transmits it to the position detection device, which uses the transmitted auxiliary position information to ascertain the position information.

The setting of the operating parameter of the vehicle system that is performed within the context of the method can relate to a driver assistance system and/or a multimedia system and/or an air conditioning system and/or an interior lighting system and/or an actuating system for at least one door and/or for a window and/or a system for adjusting a seat position. The list is merely exemplary and not conclusive.

The setting of a function of the mobile terminal that is performed within the context of the method may be limitation of the reception of incoming information contents, particularly of incoming telephone calls, text and/or multimedia messages, and/or reduction of the contents shown on a display of the mobile terminal and/or reduction of the brightness of said contents and/or shutdown of the display and/or reduction of the volume of signal tones from the mobile terminal and/or shutdown of signal tones and/or reduction of the intensity of vibration signals and/or shutdown of vibration signals and/or shutdown of the mobile terminal. The list is merely exemplary and not conclusive.

The setting of the operating parameter of the vehicle system and/or of the function of the mobile terminal is preferably temporary. The operating information that influences the respective function of the mobile terminal does not prompt the mobile terminal to be reconfigured such that it is no longer able to execute the respective function at all. Within the meaning, the term “temporary” likewise means a particular time interval, e.g. the period of the journey in which the respective function of the mobile terminal is influenced. In this case, it is possible to take account of particular criteria, such as operating parameters of the motor vehicle, that need to be present in order to bring about influencing of the functions of the mobile terminal in the first place.

The communication between the motor vehicle and the mobile terminal expediently takes place via motor-vehicle-based and terminal-based transmission and/or reception devices that form a communication link, particularly a wireless network (WLAN network, Bluetooth network, etc.).

In an advantageous refinement of the method, the control device takes account of at least one current piece of operating information from the motor vehicle and/or at least one current piece of traffic information when setting the at least one operating parameter and/or the at least one function of the mobile terminal.

Expediently, a plausibilization device is used, which checks the position information ascertained by the position detection device. The plausibilization device checks the position information from a plurality of separately operating position detection devices, for example, which accordingly plausibilize one another in terms of the position information ascertained thereby. It is also conceivable for signals delivered by a seat occupancy sensor system and/or delivered by cameras that, if need be, are arranged in the interior of the motor vehicle to be used for plausibilizing or checking the position information.

The motor vehicle and the at least one mobile terminal can form a communication system. Within the communication system, appropriate communication links provided particularly between the motor vehicle and the mobile terminal can be used to transmit information, i.e. particularly position information, registration information or control information relating to the control of relevant operating parameters of relevant motor-vehicle-based vehicle systems.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a basic illustration of a motor vehicle according to an exemplary embodiment;

FIG. 2 shows a basic illustration of a motor vehicle according to an exemplary embodiment; and

FIG. 3 shows a basic illustration of a motor vehicle according to an exemplary embodiment.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

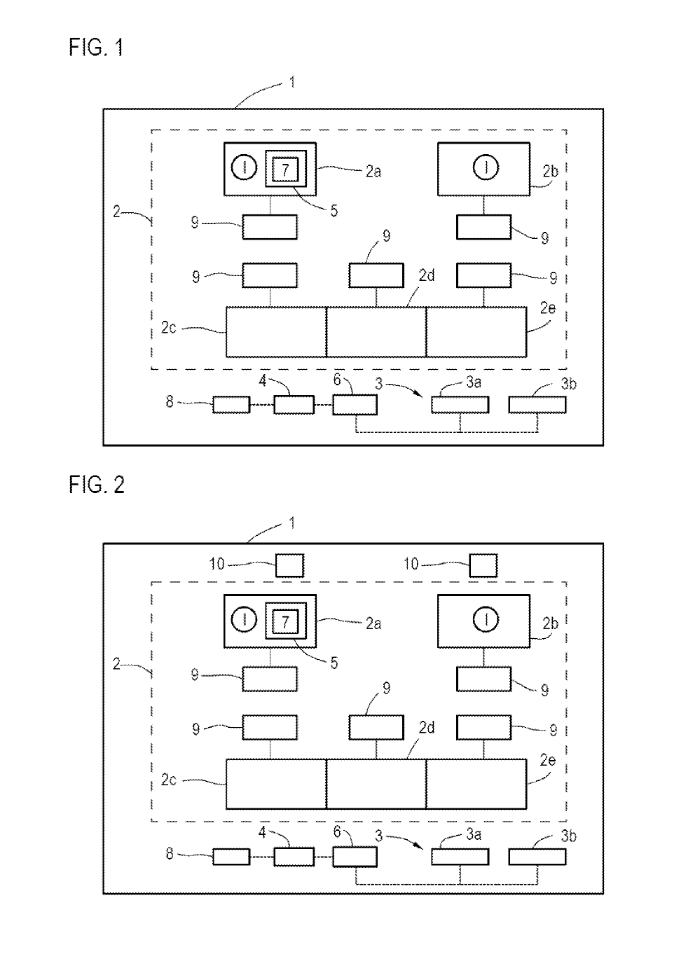

FIG. 1 shows a basic illustration of a motor vehicle 1 according to an exemplary embodiment. Usually, the passenger compartment of the motor vehicle 1 contains a plurality of seats 2, with 2a denoting the driver's seat, 2b denoting the front-seat passenger's seat and 2c-2e denoting relevant seats on the rear seat. In addition, the motor vehicle 1 comprises a plurality of vehicle systems, denoted as a whole by 3, with an air-conditioning system 3a and a multimedia system 3b being shown merely by way of example. Fundamentally, a vehicle system 3 may also be in the form of a driver assistance system and/or interior lighting system and/or actuating system for at least one door and/or a window and/or system for adjusting a seat position, for example.

A position detection device 4 can be used to detect the position of an occupant I and/or of a mobile terminal 5, in the present case a mobile telephone, for example, that is associable or associated with the occupant I within the motor vehicle 1. The position detection is effected using a piece of position information that is ascertained by the position detection device 4 and that describes the position of at least one occupant I and/or of a mobile terminal 5 that is associable or associated with the occupant I. The position information can accordingly indicate a seat position and/or role of the occupant I within the motor vehicle 1, for example. By way of example, a role of an occupant I is intended to be understood to mean the role of the driver, of the front-seat passenger or of a further passenger.

A control device 6 that communicates with the position detection device 4 and with the vehicle systems 3, particularly via a vehicle bus, can be used to make a setting, transmitted by the mobile terminal 5, for at least one operating parameter of at least one vehicle system 2 on the basis of the position information. Thus, the mobile terminal 5 can be used to make a temperature setting or a volume setting, for example. The respective setting is made for an area, hence just for one particular area or seat 2. Accordingly, by way of example, it is possible to take a piece of position information that describes the occupancy of the drivers seat 2a as a basis for setting the air conditioning system 3a just for one area, as a result of which, by way of example, a temperature setting is made just for the area of the driver that contains an occupant I together with a mobile terminal 5. Temperature settings for other occupants I, such as the front-seat passenger, are not altered. It goes without saying that the motor vehicle 1 has, for this purpose, at least one transmission and/or reception device (not shown) that forms particularly part of a motor vehicle-based wireless network, particularly a WLAN network, and by which the motor vehicle is designed to communicate with a relevant transmission and/or reception device (not shown) associated with the mobile terminal 5.

As an alternative or in addition, the control device 6 may be designed to take the position information as a basis for transmitting and setting at least one, in particular limiting, piece of operating information for the mobile terminal 5 that influences at least one position of the mobile terminal 5 and by which operating information at least one function of the mobile terminal 5 is influenced, in particular limited, accordingly.

This means that relevant functions of the mobile terminal 5 can be influenced on the basis of the current position of the mobile terminal 5 and/or the occupant I with whom the mobile terminal 5 is associated. In this case, it is possible, by way of example, for the influencing of a function of the mobile terminal 5 to be limitation of the reception of incoming information contents, particularly of incoming telephone calls, text and/or multimedia messages, and/or reduction of the contents shown on a display of the mobile terminal 5 and/or reduction of the brightness of said contents and/or shutdown of the display and/or reduction of the volume of signal tones from the mobile terminal 5 and/or shutdown of signal tones and/or a reducing intensity of vibration signals from the mobile terminal 5 and/or shutdown of vibration signals and/or shutdown of the mobile terminal 5. Accordingly, in order to focus the attention of the occupant I acting as driver on what is happening in the traffic, for example, it is possible to temporarily, that is to say for a prescribed or prescribable period, suppress audible and/or visual and/or haptic signals from the mobile terminal 5 that attract attention and are therefore distracting. It is also conceivable for the output of corresponding signals to be suppressed completely for the duration of the journey.

In order to ascertain the position information, the position detection device 4 may be designed to use terminal-specific motion signals delivered by a motion sensor system 7 that is associated with the mobile terminal 5 and that particularly has a plurality of inertial sensors (not shown). In particular, the position information is ascertained using the lateral acceleration that acts on the mobile terminal 5, said lateral acceleration varying on the basis of the position within the motor vehicle 1 during a curve through which said motor vehicle is travelling in accordance with the principle described above.

In this case, it is advantageous that additionally at least one motor-vehicle-based motion sensor system 8 that delivers motor-vehicle-specific motion signals is provided, wherein the position detection device 4 is designed to ascertain the position information by taking account of the motor-vehicle-specific motion signals. Accordingly, it is possible to distinguish motor-vehicle-based motions from terminal-based motions, as a result of which the latter can be taken as a basis for ascertaining the position information on their own. In this way, it is possible to increase the accuracy of the position information that describes the position of an occupant I and particularly the position of the mobile terminal 5 within the motor vehicle 1.

Expediently, the control device 6 takes account of at least one current piece of operating information from the motor vehicle 1 and/or of at least one current piece of traffic information when setting the at least one operating parameter and/or the at least one function of the mobile terminal 5. By way of example, the operating information may be the actual speed of the motor vehicle 1, as a result of which relevant settings, that is to say particularly the influencing of the functionality of the mobile terminal 5, are made only when a prescribed or prescribable minimum speed is exceeded. Equally, it is also possible to take account of current traffic information that can be ascertained as part of a tailback recognition system (not shown) provided on the motor vehicle, for example, as a result of which—again particularly in respect of the setting of the functionality of the mobile terminal 5—relevant operating information is transmitted and relevant settings are made on the terminal only in the presence of tailbacks or other potential dangerous situations ahead of the motor vehicle 1.

As an alternative or in addition, the position information can be ascertained using a piece of registration information that relates to registration of the mobile terminal 5 with the motor vehicle 1. That is to say that the occupant I carrying a mobile terminal 5 with him registers with or logs into the motor vehicle 1 by a data link from the mobile terminal 5. The registration information may contain a piece of information about the role of the occupant I who is registering himself, that is to say that the registration information can indicate that the respective person I is the driver, for example. Accordingly, the position of the mobile terminal 5 or of the occupant I carrying it is associated with the area of the driver's seat 2a. Accordingly, it is naturally possible for other occupants of the motor vehicle 1 to register therewith in order to make relevant settings for relevant operating parameters of the vehicle systems 3 and/or to influence the function of the mobile terminals 5 carried by said occupants.

Advantageously, a plausibilization device, in the present case in the form of seat occupancy sensors 9 associated with the respective seats 2, may also be provided that is designed to check the position information ascertained by the position detection device 4. In the exemplary embodiment shown in FIG. 1, the driver's seat 2a contains an occupant I who is carrying a mobile terminal 5 with him, which means that the position detection device 4 ascertains a corresponding piece of position information. The seat occupancy sensors 9 associated with the drivers seat 2a can be used to check and confirm the position information, since the seat occupancy sensors 9 associated with the drivers seat 2a also indicate that the driver's seat 2a contains an occupant I.

FIG. 2 shows a basic illustration of a motor vehicle 1 according to a further exemplary embodiment. The main difference from the embodiment shown in FIG. 1 is that the position detection device 4 ascertains the position information not, or not exclusively, using terminal-specific motion signals delivered by a motion sensor system 7 associated with the mobile terminal 5, but rather using a piece of locating information that is delivered by at least one locating antenna 10, provided on the motor vehicle, for locating mobile terminals 5. Corresponding locating antennas 10 are arranged at defined positions, that is to say positions associated particularly with the respective seats 2, within the motor vehicle 1, as a result of which they sense particularly a defined area for the seat 2 respectively associated therewith. The locating information is respectively ascertained using the principle of radio locating, wherein a signal intensity that varies on the basis of the distance of a mobile terminal 5 from a respective locating antenna 10 can be used to draw conclusions as to the position of a mobile terminal 5. Equally, the locating antenna 10 can also be used to locate an occupant I, since the position or change of position of said occupant brings about changes in the signal intensity of the locating antenna 10 in equal measure.

Corresponding location antennas 10 may likewise be provided within the mobile terminal 5, as a result of which the mobile terminal 5 is designed to ascertain a relevant piece of locating information that is furthermore transmitted to the position detection device 4 and converted into a corresponding piece of position information therein.

It is also conceivable for the position information to be ascertained using picture data that are recorded using a camera (not shown) in the mobile terminal 5, show the or a portion of the interior of the motor vehicle 1 and allow conclusions as to the position of the occupant I and/or of the mobile terminal 5. In this case, the occupant I and/or the mobile terminal 5 thus automatically records relevant picture data from the inside of the motor vehicle 1, from which picture data the position detection device 4 detects characteristic features of the interior of the motor vehicle 1, and in this respect draws conclusions as to the position of the occupant I or the mobile terminal 5, using suitable picture evaluation mechanism. By way of example, characteristic features of the interior of the motor vehicle 1 are the steering wheel, the rear view from the drivers seat 2a or the rear view from the front-seat passenger's seat 2b.

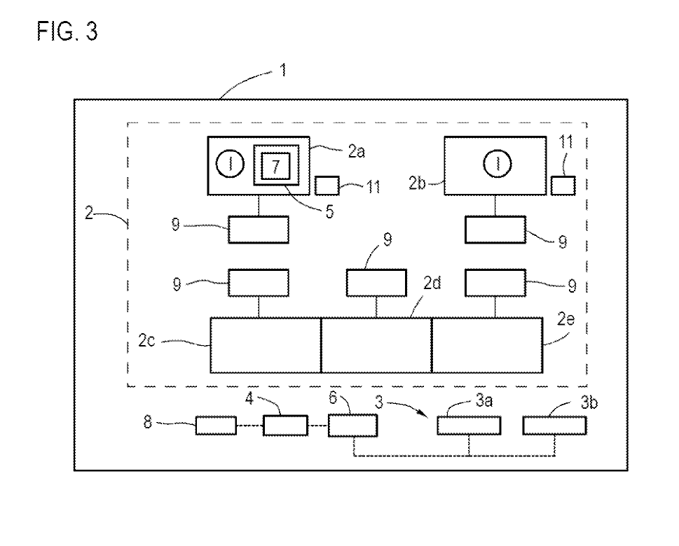

In the case of the embodiment of the motor vehicle 1 that is shown in FIG. 3, markers 11 associated with the respective seats 2 are arranged in the interior and can be detected by the mobile terminal 5, for example using a camera, a scanner or the like. From the detection of the marker 11, the mobile terminal 5 can ascertain a piece of auxiliary position information and can transmit said information to the position detection device 4. Using the transmitted auxiliary position information, the position detection device 4 ascertains the position information. By way of example, the markers 11 may be present as a barcode or the like and may be mounted on some of the respective seats 2, for example.

All of the variants for ascertaining the position information that are shown in FIGS. 1 to 3 can also be implemented in parallel. Accordingly, they are able to plausibilize one another. By way of example, it is conceivable for a first piece of position information to be ascertained using a motion sensor system 7 of a mobile terminal 5, shown in FIG. 1, and for a second piece of position information to be ascertained using the locating antennas 2, shown in FIG. 2. By comparing the respectively different ascertained pieces of position information it is possible to validate them.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d1865 (Fed. Cir. 2004).

1-15. (canceled)

16. A motor vehicle comprising:
a position detection device to determine position information that describes a position of an occupant of the motor vehicle and/or a position of a mobile telephone, that is associated with the occupant of the motor vehicle, the position information being determined based on position data delivered by the mobile telephone and/or based on registration information delivered by the mobile telephone; and
a control device to:
set an operating parameter of a vehicle system based on control information delivered by the mobile telephone and based on the position information or
set an operating parameter of the vehicle system based on control information delivered by the mobile telephone and based on the position information, and to transmit operating information that influences a function of the mobile telephone to the mobile telephone based on the position information.

17. The motor vehicle as claimed in claim 16, wherein
the position detection device determines the position information using the position data delivered by the mobile telephone, and
the position data comprises terminal-specific motion signals produced by a motion sensor system of the mobile telephone.

18. The motor vehicle as claimed in claim 17, wherein
the terminal-specific motion signals identify a lateral acceleration that acts on the mobile telephone, and
the position detection device determines the position information using the lateral acceleration that acts on the mobile telephone while the motor vehicle is travelling through a curve, the lateral acceleration varying based on position of the mobile telephone within the motor vehicle during the curve.

19. The motor vehicle as claimed in claim 17, wherein
the motor vehicle further comprises a motor-vehicle-based motion sensor system that delivers motor-vehicle-specific motion signals, and
the position detection device determines the position information based on the motor-vehicle-specific motion signals and based on the terminal-specific motion signals.

20. The motor vehicle as claimed in claim 19, wherein
the terminal-specific motion signals identify a lateral acceleration that acts on the mobile telephone,
the motor-vehicle-specific motion signals identify a lateral acceleration that acts on the motor-vehicle-based motion sensor system, and
the position detection device determines the position information by comparing the lateral acceleration that acts on the mobile telephone with the lateral acceleration that acts on the motor-vehicle-based motion sensor system, while the motor vehicle is travelling through a curve, the lateral acceleration varying based on positions of the mobile telephone and the motor-vehicle-based motion sensor system within the motor vehicle during the curve.

21. The motor vehicle as claimed in claim 20, wherein the position detection device compares lateral acceleration during both a left curve and a right curve.

22. The motor vehicle as claimed in claim 19, wherein the motor-vehicle-based motion sensor system comprises an inertial sensor.

23. The motor vehicle as claimed in claim 16, wherein
the motor vehicle further comprises a locating antenna, and
the position detection device determines the position information using locating information delivered by the locating antenna.

24. The motor vehicle as claimed in claim 16, wherein
the motor vehicle further comprises a plurality of locating antennas at respective different locations within the motor vehicle,
the position information is determined based on position data delivered by the mobile telephone,
the position data comprises wireless signals transmitted by the mobile telephone and received at the locating antennas, and
the position detection device determines the position information by comparing signal strengths of the wireless signals received at the locating antennas.

25. The motor vehicle as claimed in claim 16, wherein the position detection device determines the position information using picture data recorded by a camera in the mobile telephone, the picture data showing a portion of an interior of the motor vehicle.

26. The motor vehicle as claimed in claim 16, wherein
the position detection device determines the position information based on registration information delivered by the mobile telephone, and
the registration information identifies the mobile telephone as being previously registered with the motor vehicle and relates to a predetermined occupant position within the motor vehicle.

27. The motor vehicle as claimed in claim 16, wherein
the motor vehicle further comprises a marker provided in an interior of the motor vehicle such that the marker can be detected by the mobile telephone,
the position information is determined based on position data delivered by the mobile telephone, and
the mobile telephone, upon detecting the marker, produces a piece of auxiliary position information, which is transmitted to the position detection device as the position data.

28. The motor vehicle as claimed in claim 16, wherein the operating parameter set by control device relates to at least one of a driver assistance system, a multimedia system, an air-conditioning system, an interior lighting system, an actuating system for a door of the motor vehicle, an actuating system for a window of the motor vehicle, and a system for adjusting a seat position.

29. The motor vehicle as claimed in claim 16, wherein
the operating parameter set by the control device relates to an air conditioning system,
the control information delivered by the mobile telephone specifies an air conditioning setting, and
the air conditioning setting is implemented only at the position of the occupant of the motor vehicle.

30. The motor vehicle as claimed in claim 16, wherein
the control device sets the operating parameter of the vehicle system and transmits the operating information that influences the function of the mobile telephone to the mobile telephone, and
the function of the mobile telephone is at least one function selected from the group consisting of limiting reception of incoming telephone calls, limiting reception of incoming text messages, limiting reception of incoming multimedia messages, reducing contents shown on a display of the mobile telephone, reducing a brightness of the display of the mobile telephone, shutting down the display of the mobile telephone, reducing a volume of signal tones produced by the mobile telephone, shutting down signal tones produced by the mobile telephone, reducing an intensity of vibration signals produced by the mobile telephone, shutting down vibration signals produced by the mobile telephone, and shutting down the mobile telephone.

31. The motor vehicle as claimed in claim 28, wherein the control device only temporarily sets the operating parameter of the vehicle system and/or the operating information only temporarily influences the function of the mobile telephone.

32. The motor vehicle as claimed in claim 16, wherein the motor vehicle further comprises a wireless transmission device to perform wireless communication with the mobile telephone.

33. The motor vehicle as claimed in claim 16, wherein
the control device sets the operating parameter of the vehicle system and transmits the operating information that influences the function of the mobile telephone to the mobile telephone, and
the function of the mobile telephone is influenced to take into account a current operating condition of the motor vehicle and/or to take into account current traffic conditions.

34. The motor vehicle as claimed in claim 33, wherein
the control device at least partially disables the mobile telephone when the motor vehicle is travelling at a predetermined speed or when the motor vehicle is travelling in hazardous traffic conditions.

35. The motor vehicle as claimed in claim 16, wherein the motor vehicle further comprises plausibilization device to check the position information determined by the position detection device.

36. The motor vehicle as claimed in claim 35, wherein the plausibilization device comprises a plurality of seat occupancy sensors.
